(19) United States
(12) Patent Application Publication
(10) Pub. No.: US 2008/0016846 A1
(43) Pub. Date: Jan. 24, 2008

(54) System and method for cooling hydrocarbon-fueled rocket engines

(75) Inventor: Louis J. Spadaccini, Manchester, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/488,393

(22) Filed: Jul. 18, 2006

(51) Int. Cl. F02K 11/00

(52) U.S. Cl. 60/267

(57) ABSTRACT

A rocket engine combustion chamber wall operates as a heat exchange section through which the fuel passes in a heat exchange relationship. By first passing the fuel through a deoxygenator system fuel stabilization unit (FSU), oxygen is selectively removed such that the heat sink capacity of the fuel is increased which translates into an increased impulse power rocket engine.

### BACKGROUND OF THE INVENTION

The present invention relates to a fuel system for a rocket engine, and more particularly to a fuel system with a deoxygenator in which oxygen is selectively removed such that the useable heat sink capacity of the fuel is significantly increased which translates into an increased impulse power rocket engine.

With the increasing need for safe storable propellant systems, Kerosene-fueled reusable expander cycle rocket engines are of growing prevalence. Kerosene-fueled expander cycle rocket engines operate at higher combustion pressures (to increase thrust and specific impulse, and reduce weight) and utilize more of the heat sink capability of the fuel to accommodate the increased heat fluxes that result.

Heat created during combustion in a rocket engine is contained within the exhaust gases. Most of this heat is expelled along with the gas that contains it; however, heat is still transferred to the thrust chamber walls in significant quantities. A fuel cooled cooling jacket about the main combustion chamber utilizes the heat sink capacity of the fuel to cool the combustion chamber and vaporize the fuel in a regenerative cooling cycle. The fuel vapor is passed through the turbine to generate power for the pumps that send propellants to the combustion chamber and then injected into the main chamber to burn with the oxidizer. This cycle is typically utilized with fuels such as hydrogen or methane, which have a low boiling point and can be vaporized easily. The propellants are burned at the optimal mixture ratio in the main chamber, and typically no flow is dumped overboard; however, the heat transfer to the fuel limits the power available to the turbine, which typically restricts an expander cycle rocket engine to small and midsize engines. A variation of the system is the open, or bleed, expander cycle, which uses only a portion of the fuel to drive the turbine. In this variation, the turbine exhaust is dumped overboard to ambient pressure to increase the turbine pressure ratio and power output. This can achieve higher chamber pressures than the closed expander cycle although at lower efficiency because of the overboard flow.

Regenerative cooling of the rocket combustion chamber with RP-1 (similar to JP-7) is feasible up to a point where the coolant reaches a temperature limit defined by deposit formation (coking). Coke deposition on the walls of the cooling passages in the combustion chamber liner and nozzle obstructs the fuel flow and reduces heat transfer, resulting in progressively increasing wall temperature and a potential failure. Because of its superior thermal conductivity, copper is often utilized for forming the regenerative cooling passages in the thrust chamber. However, copper is known to be a catalyst that accelerates liquid hydrocarbon fuel thermal oxidation, increasing coke formation and diminishing the maximum heat flux that can be absorbed.

There have been various attempts to suppress thermal oxidation and coke deposition, but they have generally proven to be unsuccessful or impractical. Fuel additives have been used with some success to achieve a modest (<100 F) increase in the allowable temperature of jet fuels, but their effectiveness in RP-1 and in copper-wall cooling passages is unknown. Ceramic coatings, proposed to block the chemically active copper wall, may delay coke deposition to slightly higher temperature, but they will not affect thermal oxidation reactions in the bulk flow, and they will introduce added thermal resistance. The use of an onboard inert gas generator system (OBIGGS) to reduce the oxygen concentration in the fuel tank below the flammability limit (˜9 vol. %) is not enough for coke suppression, while attempts to deoxygenate fuel by sparging with nitrogen have proven to be costly, heavy and bulky.

Accordingly, it is desirable to provide for the deoxygenation of hydrocarbon fuel in a size and weight efficient system to increase the heat sink capacity of the fuel which translates into increased power available to the turbine and thus an increase impulse power rocket engine.

### SUMMARY OF THE INVENTION

The present invention is directed at suppressing coke formation in liquid-hydrocarbon-fueled rockets to increase the heat flux that can be absorbed and permit operation at higher combustion chamber pressures. A Fuel Stabilization Unit (FSU) is utilized for in-line deoxygenation of the fuel prior to its use as a coolant. By removing oxygen that is dissolved in the fuel (through prior exposure to air), the FSU enables the fuel to be heated significantly before thermal decomposition begins, thereby increasing the cooling capacity that is available without coke formation.

The present invention therefore provides for the deoxygenation of hydrocarbon fuel in a size and weight efficient system to increase the heat sink capacity of the fuel which translates into an increased impulse power rocket engine.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1A is a schematic view of a rocket engine embodiment for use with the present invention;

FIG. 1B is a schematic view of a rocket engine fuel system with a deoxygenator system;

FIG. 2A is an expanded perspective view of a deoxygenator system; and

FIG. 2B is an expanded sectional view of a flow plate assembly illustrating a fuel channel and an oxygen-receiving vacuum or sweep gas channel.

### DETAILED DESCRIPTION OF THE PREFERRED EMBODIMENT

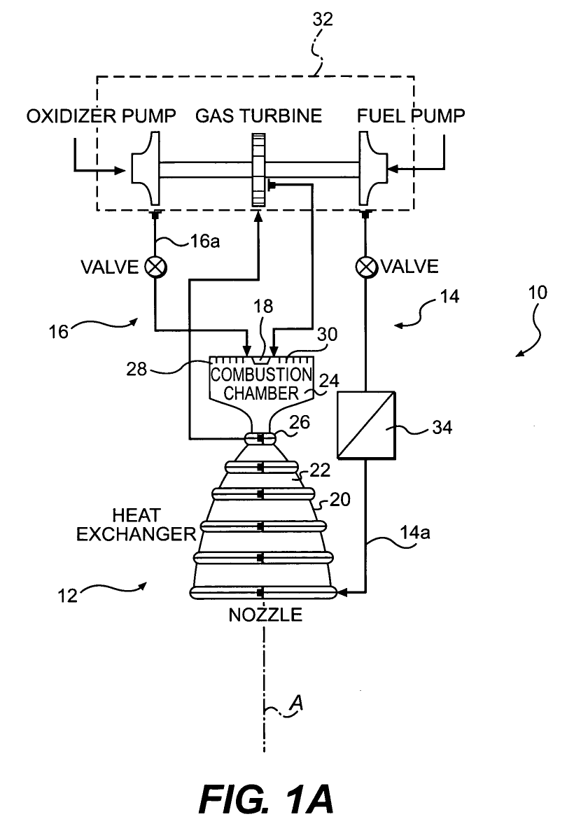

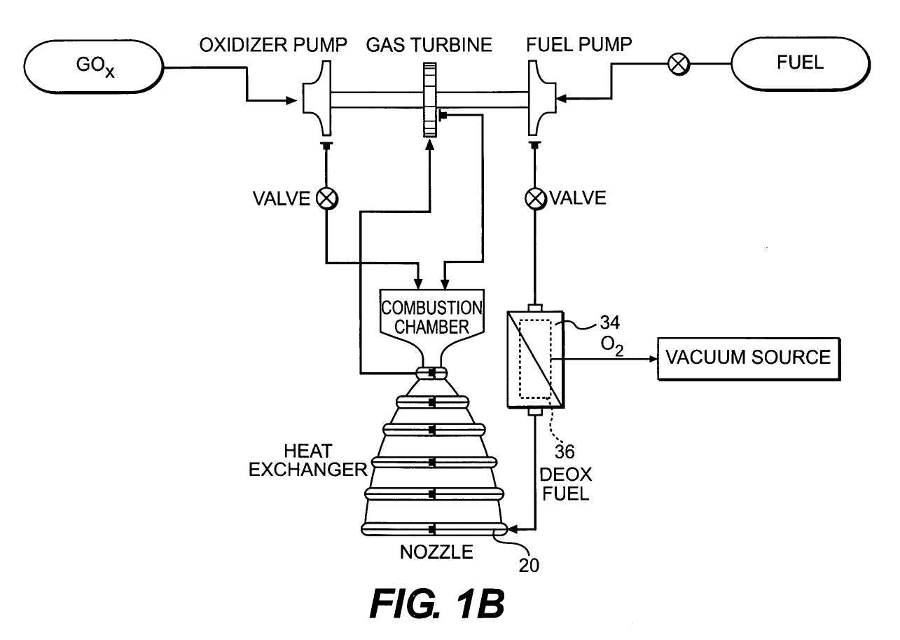

FIG. 1A illustrates a schematic view of a rocket engine 10. The engine 10 generally includes a nozzle assembly 12, a fuel system 14, an oxidizer system 16 and an ignition system 18. The fuel system 14 and the oxidizer system 16 preferably provide a gaseous propellant system of the rocket engine 10, however, other propellant systems such as liquid will also be usable with the present invention. It should be further understood that although an expanded cycle type rocket engine is illustrated in the disclosed embodiment other rocket engine power cycle types including but not limited to Gas-generator cycle, Staged combustion cycle, and Pressure-fed cycle will also benefit from the present invention.

A combustion chamber wall 20 about a thrust axis A defines the nozzle assembly 12. The combustion chamber wall 20 defines a thrust chamber 22, a combustion chamber 24 upstream of the thrust chamber 22, and a combustion chamber throat 26 therebetween. The nozzle assembly 12 includes an injector face 28 with a multitude of fuel/oxidizer injector elements 30 (shown schematically) which receive fuel which passes first through the fuel cooled combustion chamber wall 20 fed via fuel supply line 14a of the fuel system 14 and an oxidizer such as Gaseous Oxygen (GOx) through an oxidizer supply line 16a of the oxidizer system 16.

Heat in the fuel cooled combustion chamber wall 20 serves to superheat and/or at least partially vaporize the fuel. The fuel vapor is then passed through a turbine 32 and injected into the combustion chamber 24 to burn with the oxidizer as generally understood. Preferably, all the propellants are burned at the optimal mixture ratio in the combustion chamber 24, and typically no flow is dumped overboard; however, heat transfer to the fuel is typically the limiting factor of the power available to the turbine 32.

Referring to FIG. 1B, the rocket engine 10 of the present invention utilizes a deoxygenator system 34 within the fuel system 14 upstream of the fuel cooled combustion chamber wall 20. The combustion chamber wall 20 operates as a heat exchange section through which the fuel passes in a heat exchange relationship. By first passing all or a portion of the fuel through the deoxygenator system 34, oxygen is selectively removed such that the heat sink capacity of the fuel is increased which translates into increased power available to the turbine 32 and thus an increase impulse power rocket engine 10. Typically, lowering the oxygen concentration to approximately 5 ppm is sufficient to overcome the coking problem and allows the fuel to be heated to approximately 650° F. during heat exchange, for example. It should be understood that even a relatively low reduction of the oxygen concentration will provide significant benefits in liner lifer as deoxygenated fuel will primarily be utilized to the nozzle throat and areas where the heat fluxes and coke deposits would otherwise be relatively high.

As the fuel passes through the deoxygenator system 34, oxygen is selectively removed into a vacuum or sweep-gas system 36. The sweep gas may be any gas that is essentially free of oxygen. The deoxygenated fuel flows from a fuel outlet of the deoxygenation system 34 via a deoxygenated fuel conduit, to the fuel cooled combustion chamber wall 20. It should be understood that although a particular component arrangement is disclosed in the illustrated embodiment, other arrangements will benefit from the instant invention.

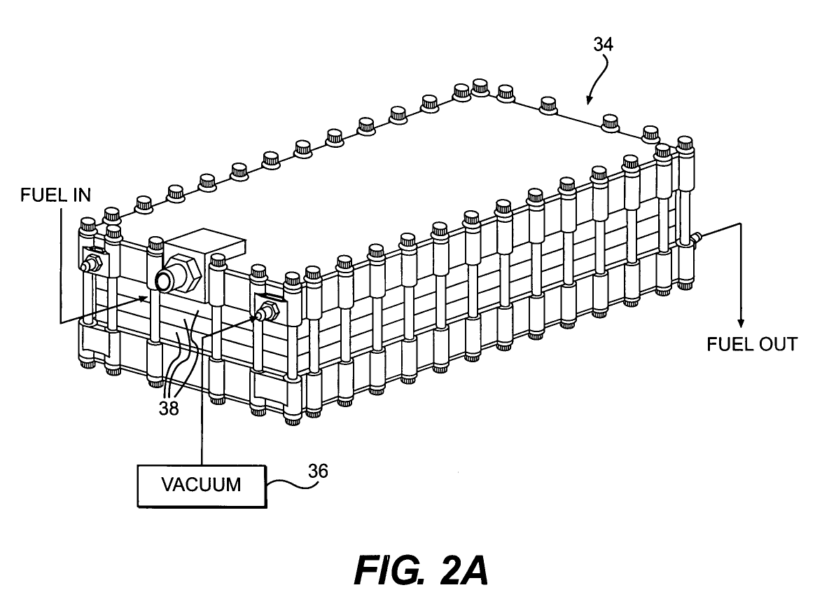

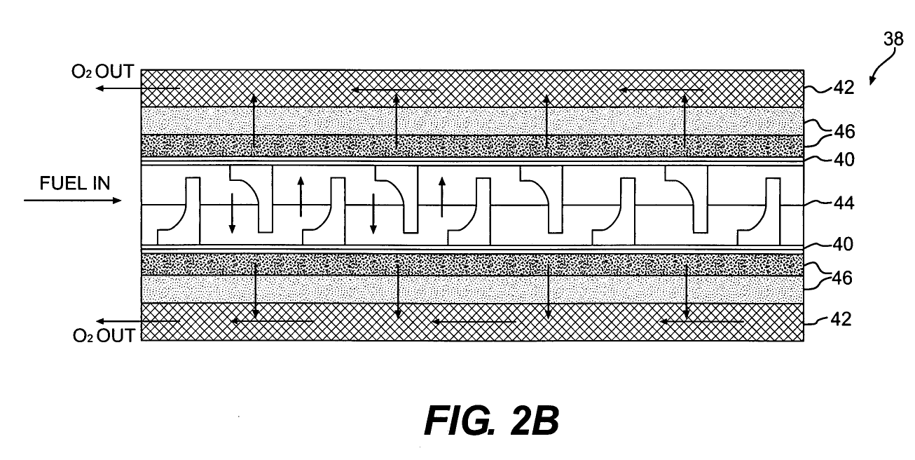

Referring to FIG. 2A, the deoxygenator system 14 preferably includes a multiplicity of gas/fuel flow-channel assemblies 38 (FIG. 2B). The assemblies 38 include a oxygen permeable membrane 40 between a fuel channel 44 and an oxygen receiving vacuum or sweep-gas channel 42 which can be formed by a supporting mesh which permits the flow of nitrogen and/or another oxygen-free gas. It should be understood that the channels may be of various shapes and arrangements to provide a oxygen partial pressure differential, which maintains an oxygen concentration differential across the membrane to deoxygenate the fuel.

The oxygen permeable membrane 40 allows dissolved oxygen (and other gases) to diffuse through angstrom-size voids but excludes the larger fuel molecules. Alternatively, or in conjunction with the voids, the oxygen permeable membrane 40 utilizes a solution-diffusion mechanism to dissolve and diffuse oxygen (and/or other gases) through the membrane while excluding the fuel. The family of Teflon AF which is an amorphous copolymer of perfluoro-2,2-dimethyl-1,3-dioxole (PDD) often identified under the trademark “Teflon AF” registered to E. I. DuPont de Nemours of Wilmington, Del., USA, and the family of Hyflon AD which is a copolymer of 2,2,4-trifluoro-5-trifluoromethoxy-1,3-dioxole (TDD) registered to Solvay Solexis, Milan, Italy have proven to provide effective results for fuel deoxygenation.

Fuel flowing through the fuel channel 44 is in contact with the oxygen permeable membrane 40. Vacuum creates an oxygen partial pressure differential between the inner walls of the fuel channel 44 and the oxygen permeable membrane 40 which causes diffusion of oxygen dissolved within the fuel to migrate through the porous support 46 which supports the membrane 40 and out of the deoxygenator system 34 through the oxygen receiving channel 42.

The specific quantity of assemblies 38 are determined by application-specific requirements, such as fuel type, fuel temperature, and mass flow demand from the engine. Further, different fuels containing differing amounts of dissolved oxygen may require differing amounts of deoxygenation to remove a desired amount of dissolved oxygen. For further understanding of other aspects of one membrane based fuel deoxygenator system and associated components thereof which are capable of processing high flow rates characteristic of rocket engines in a compact and lightweight assembly, and lowering dissolved oxygen concentration sufficiently to suppress coke formation, attention is directed to U.S. Pat. No. 6,315,815 entitled MEMBRANE BASED FUEL DEOXYGENATOR; U.S. Pat. No. 6,939,392 entitled SYSTEM AND METHOD FOR THERMAL MANAGEMENT and U.S. Pat. No. 6,709,492 entitled PLANAR MEMBRANE DEOXYGENATOR which are assigned to the assignee of the instant invention and which are hereby incorporated herein in their entirety.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

For further understanding of other aspects of the airflow distribution networks and associated components thereof, attention is directed to U.S. Pat. No. 5,327,744 which is assigned to the assignee of the instant invention and which is hereby incorporated herein in its entirety.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A rocket engine comprising:
a fuel deoxygenator system; and
a fuel cooled combustion chamber wall in fluid communication with said deoxygenator system.

2. The rocket engine as recited in claim 1, wherein said fuel cooled combustion chamber wall defines a thrust chamber, a combustion chamber upstream of the thrust chamber, and a combustion chamber throat therebetween.

3. The rocket engine as recited in claim 1, further comprising a turbine in fluid communication with a fuel system through said fuel cooled combustion chamber wall.

4. A rocket engine comprising:
a thrust chamber assembly having a fuel cooled combustion chamber wall;
a fuel system in communication with said thrust chamber assembly through said fuel cooled combustion chamber wall;
an oxidizer system in communication with said thrust chamber assembly; and
a deoxygenator system in fluid communication with said fuel cooled combustion chamber wall.

5. The rocket engine as recited in claim 4, wherein said thrust chamber wall assembly defines a thrust chamber, a combustion chamber upstream of the thrust chamber, and a combustion chamber throat therebetween.

6. The rocket engine as recited in claim 4, wherein said deoxygenator system is upstream of said fuel cooled combustion chamber wall

7. A method of increasing a thrust impulse of a rocket engine comprising the steps of:
(A) deoxygenating a fuel;
(B) communicating the deoxygenated fuel through a fuel cooled combustion chamber wall; and
(C) communicating the deoxygenated fuel from the fuel cooled combustion chamber wall into a thrust chamber assembly.

8. A method as recited in claim 7, wherein said step (C) further comprises:
(a) communicating the deoxygenated fuel from the fuel cooled combustion chamber wall to a turbine prior to communication into the thrust chamber assembly.

9. A method as recited in claim 7, wherein said step (C) further comprises:
(a) partially vaporizing the deoxygenated fuel within the fuel cooled combustion chamber wall;
(b) communicating the partially vaporized deoxygenated fuel from said step (a) to a turbine; and
(c) communicating the partially vaporized deoxygenated fuel from said step (b) to the thrust chamber assembly.

10. A method as recited in claim 7, wherein said step (C) further comprises:
(a) superheating the deoxygenated fuel within the fuel cooled combustion chamber wall;
(b) communicating the superheated deoxygenated fuel from said step (a) to a turbine; and
(c) communicating the superheated vaporized deoxygenated fuel from said step (b) to the thrust chamber assembly.
